(19) United States
(12) Patent Application Publication
(10) Pub. No.: US 2010/0287281 A1
(43) Pub. Date: Nov. 11, 2010

(54) TELECOMMUNICATION NETWORK RESOURCE MANAGEMENT BASED ON SOCIAL NETWORK CHARACTERISTICS

(75) Inventor: Thomas M. Tirpak, Glenview, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/463,445

(22) Filed: May 11, 2009

(51) Int. Cl. G06F 15/16

(52) U.S. Cl. 709/226

(57) ABSTRACT

An apparatus and method of telecommunication network resource management based on social network characteristics includes a first step 200 of retrieving data relating to social network characteristics associated with a user. A next step 202 includes computing social network metrics based on the data. A next step 204 includes defining a priority score for a session with the user based on the social network metrics. A next step 206 includes assigning resources for the communication session based on the priority score, wherein the resources can include a power operational mode for the session.

### TECHNICAL FIELD OF THE INVENTION

This invention relates generally to telecommunication networks, and more particularly to telecommunication network resource management based on social network characteristics.

### BACKGROUND OF THE INVENTION

Today, telecommunication systems exist that conserve power by putting a communication device into different power operating modes depending on the demand for their functionality, such as an “active” or “talk” mode, and a “sleep” or “idle/standby” mode for cellular telephones. However, such methods are based on a current activity of the communication device. For example; when there is a change, it is necessary command the communication device to “wake up” to accept a command or message (and typically there is a lag time before the device listens to such commands). This causes delays in communications and can waste resources.

One approach to manage resources is to assign priority classes that reflect roles (and therefore a user's anticipated needs for communication resources), e.g., Fire Chief, Fire Truck Driver, Incident Commander, Volunteer, etc. In this way, telecommunications resources are managed to ensure that the highest priority users' needs are met. In addition, devices with power-save features may be configured to reduce power consumption, if possible, while meeting the needs of only the highest priority users. However, there are two limitations of this approach: (1) it does not consider a user's needs resulting from his/her emergent role in a social network, e.g., Ms. Volunteer happens to be the closest to the accident scene, and greater resources are required because many people want to contact her; and (2) it is not effective for operating scenarios that fall between the (typically three to ten) priority classes determined by a network administrator, i.e., the “rounding error” between the discrete set of priority classes represents a lost opportunity for power savings.

Accordingly, there is thus a need for an improved technique for resource management and power savings in a communication system.

### BRIEF DESCRIPTION OF THE DRAWINGS

The accompanying figures, where like reference numerals refer to identical or functionally similar elements throughout the separate views and which together with the detailed description below, serve to further illustrate various embodiments and to explain various principles and advantages all in accordance with the present invention.

FIG. 1 illustrates a simplified block diagram of a telecommunication network in accordance with the embodiments of the present invention;

FIG. 2 illustrates a method in accordance with the present invention;

FIG. 3 is a flow diagram of a first use case in accordance with the present invention; and

FIG. 4 is a flow diagram of a second use case in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

The present invention provides an improved technique for resource management in a communication system that utilizes social network characteristics. As used herein, a social network is a social structure having a group of people that are linked together by one or more common links. These links may include friendship interdependency, familial ties, employment status, common likes, common dislikes, common subject matter interests, and so forth. The members or participants of a social network are generally referred to as “nodes.” Each node is linked to another by a relationship or communication channel, often called a “tie” by which information is shared.

The present invention can be deployed within (and operate in parallel with) multiple resources in a telecommunication network. One may consider it a “framework” in that the present invention enables peer-to-peer collaboration to optimize resource allocations, e.g., transmitted power. The instantiation of the present invention at the nodes/resources in the network (1) collects information available at that node, (2) issues information requests to other nodes via communication channels, e.g., control channel, available at that node, and (3) adapts/advises the native resource allocation methods active in that node.

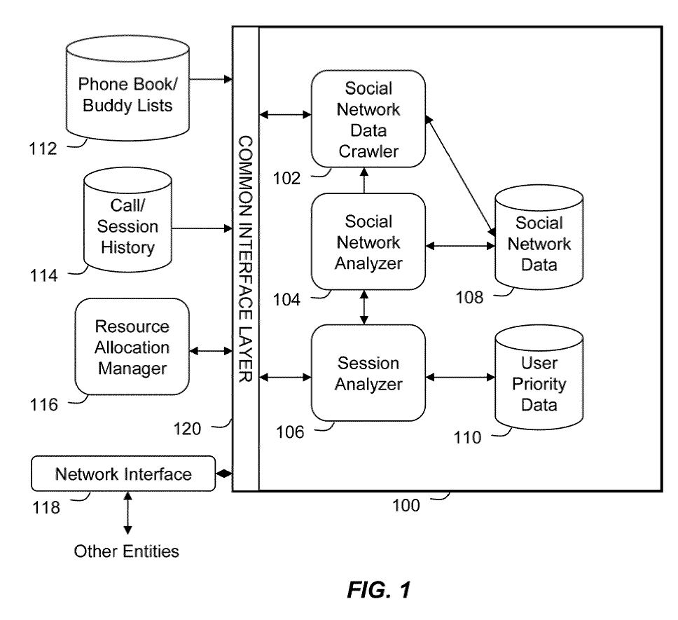

Referring to FIG. 1 illustrates a simplified hardware block diagram of a network entity 100 in a network, in accordance with the present invention. The network can be a server-client type network, a peer-to-peer network, or other suitable communication network. The network entity 100 includes a Social Network Data Crawler 102, a Social Network Analyzer 104, a Session Analyzer 106, and storage for Social Network Data 108 and User Priority Data 110. The network entity 100 includes a common interface layer 120 used to connect to a Resource Allocation Manager 116, a network interface 118 for communicating with other network entities, and storage for a Phone Book/Buddy Lists 112 and a Call/Session History 114. It should be noted that the Resource Allocation Manager 116, Phone Book/Buddy Lists 112, and Call/Session History 114 can be contained within the network entity 100 or provided separately (as shown) in the network. The diagram is intended to be illustrative only. Other configurations and devices suitable for use will be obvious to those of ordinary skill in the art having the benefit of this disclosure. Note also that not all components shown are necessary to practice embodiments of the invention.

In operation, the Social Network Data Crawler 102 (SNDC) observes user interaction or communication sessions in one or more social networks. Users can be a mobile telephone, pager, computer, gaming device, multimedia device, personal electronic device such as a portable music player, or personal digital assistant, which can have individual preferences stored therein. The user is capable of electronic communication with other user devices. The SNDC 102 retrieves available social network characteristic data relating to users of a social network on a periodic basis, e.g., every hour, or event-driven basis, e.g., when a call session is initiated. Social network characteristics can be obtained by many means. For example, observations of electronic communications between users of the network, and message paths through which information travels, and interactions therebetween can be used to obtain social network characteristics. Alternatively, the social network characteristics of users may be retrieved from a data base 108, or from each user device individually. Data may include actual/historical links in a Social Network 108, e.g., the identities (IDs) of a session originator and a session target. Data may also include intended links, e.g., the IDs of users in a phone book, speed-dial, or buddy list 112. Different types of network entities (device, cell site, etc.) will typically have different types of data. The SNDC 102 may also address its queries to entities other than the one to which it is logically associated through the network interface 118.

In one embodiment, the SNDC 102 listens to information broadcast by other entities through the network interface 118, and analyzes any messages labeled as applicable to Social Networks. For example, the SNDC 102 can determine the role of each user of the social network by implicit analysis of each user's interaction with the network and other users. Characteristics of interaction include each user's participation, access to content, recency of interaction, interaction frequency, and so forth. In addition, the SNDC 102 can look at caller-callee history, query Social Networking sites in which the user is participating, retrieve information from the buddy list on the device, query a white list-black list on the device or network service provider, and/or obtain other relationship information that the user has entered. Relevant data are forwarded to the Social Network Data 108 (SND) store.

The Social Network Analyzer 104 (SNA) computes node-based, link-based, and network-based metrics characterizing the Social Network represented by the available Social Network Data 108 (SND). These metrics can include at least one of: Closeness Betweenness, Centrality Degree, Centralization, Clustering Coefficient, Cohesion, Flow Betweenness Centrality, Eigenvector Centrality, Path Length, Prestige, Radiality, Reach, Structural Cohesion, Structural Equivalence, Structural Holes, and Density, as are known in the art. The SNA 104 can communicate with the SNDC 102 to request additional data needed for calculating specific metrics.

As and when needed, the Resource Allocation Manager 116 (RAM) queries the Session Analyzer 106 (SA) regarding the recommended priority of resources for a session associated with a given set of users. In one embodiment, the RAM 116 can provide information about multiple sessions; the SA 106 initiates the calculation of metrics based on the aggregate Social Network for the users participating in these sessions; and the RAM 116 subsequently applies the calculated priority score to all these sessions.

The SA 106 queries the SNA 104 to obtain relevant metrics. Subsequently, the SA 106 combines two or more metrics, preferably according to their relative weights (either pre-specified or dynamically assigned by the RAM 116), and outputs a priority score representing the relative importance of the given session.

The algorithms operative in the RAM 116 implement rule sets that identify (on an ongoing basis) which of the available operation modes, such as “sleep mode” and “full power mode”, should be utilized for one session, multiple sessions, or all sessions. The specific resource managed by the RAM 116 depends on the type of entity in which the RAM is operating, e.g., transmit power for a cell site.

Evaluations completed by the SA 106 are forwarded to the User Priority Data 110 (UPD) store, and retained for a period of time, thereby enabling quick responses for previously considered scenarios, i.e., without needing to query the SNA 104, and “stable prioritization”, i.e., where scores reflect previously computed scores.

In a preferred embodiment, it is envisioned that the Social Network Data Crawler function is embodied in a Long Term Evolution X2 peer-to-peer interface utilized to communicate data requests and query results with the Social Network Data. For data broadcast to the network nodes in a peer-to-peer topology, i.e., without reliable access to a Network Management System (NMS), it is envisioned that the present invention would operate in “store and forward mode” for certain priority data types, e.g., the IDs of frequent callers. Namely, data that one node receives, that meet its criteria for priority data, are subsequently forwarded to its neighbors. One of the existing peer-to-peer protocols could implement this functionality.

The SNDC would need to know the types and formats of one or more data types available from other nodes with which it communicates, such as shown in Table 1.

TABLE 1
Social Network Data Types

| Node Type | Available Social Network Data Types |
|---|---|
| Mobile | Phone Book Entry (implies social network linkage between |
| Device | device owner and the owner of another device), Recent |
| | Call History (implies linkage between calling device and |
| | called device), Buddy List used by applications running |
| | on the mobile device. |
| Base Station | Session Log, Call Log |
| Backhaul | Session Log, Call Log |
| NMS | Session Log, Call Log, Billing Records for subscribers |

In another embodiment, the SNDC on a first node would query an SNDC on a second node to obtain an inventory of data relevant to Social Networks. Subsequently, the first node may request one or more data sets from the second node. Data can be communicated in a Knowledge Container, which is a flexibly structured XML file that includes both the raw data, e.g. a Phone Book entry in the native format for a mobile device, and instructions for how to parse/interpret/ /use it.

Communication from the SNDC to the SNA occurs primarily via the Social Network Database. On an ongoing basis, as the SNDC obtains information related to Social Network in which the given node participates, it creates new records in the Social Network Database. The records for each linkage in the Social Network are shown in Table 2.

TABLE 2
Social Network Linkage Records

| Field | Example |
|---|---|
| Node 1 ID | 8475551234 |
| Node 1 Alias (optional) | ATT002 |
| Node 2 ID | 8475554321 |
| Node 2 Alias (optional) | CEMX61 |
| Link Type | Voice Call |
| Link Data 1 Name (optional) | Call Duration |
| Link Data 1 Value (optional) | 14.0 |
| Link Data 2 Name (optional) | Call Priority |
| Link Data 2 Value (optional) | 1 |
| Timestamp | 1/6/2009 15:33:00 |
| Data Source | 8475551234 Call History |

The SNA subsequently queries the Social Network Database for subsets of the available information, e.g., records with “CEMX61”, records whose source is “8475551234 Call History”, or records created within the last 30 days.

Communication from the SNA to the SNDC consists of requests to crawl for specific types of information, e.g., records about “ATT002”, and occurs on an as needed basis. One example of an event triggering such a request is when the Session Analyzer (SA) is responding to a request by the Resource Allocation Manager (RAM) involving a Node ID which the SNA has not seen before. Specifically, the given node does not occur in any of its Social Network models. (These models are stored in persistent memory in the Social Network Database. In one embodiment, these network link models are also stored in local memory for fast access.) Another example of a triggering event is when the SA is analyzing a session utilizing resources from a different priority class that previously considered, e.g., single-channel data call vs. multi-channel data call; the SNA subsequently asks the SNDC to crawl for data that may include this new “Link Type” or other “Link Data” that are relevant to the prioritization of sessions with these resources.

The Session Analyzer obtains social network metrics from the SNA. In one embodiment, a set of N basic metrics is combined as follows to generate a priority score for a given user or given session (involving multiple users):

$$\frac{1}{N} {\sum }_{i}^{N} {Metric}_{i} * {MetricWeight}_{i}$$

The default version is to weight the metrics equally. It should be noted that whereas some metrics can be defined for a single node (user), other metrics are for sets of nodes.

In another embodiment, the metric weights depend on the resource set (j) for which user (i) is making a request.

$$\frac{1}{N} {{\sum }_{i}}^{N} {Metric}_{i} * {MetricWeight}_{ij}$$

Several examples are presented for obtaining a priority score.

A first example includes prioritizing a request for the floor in a Group Call. Requesting the floor implies the need to simultaneously communicate with a group of users. In this example:

Priority=0.2*Degree+0.8*Closeness

A second example includes prioritizing a request for ringing a phone with a low battery condition. Requesting to expend limited power resources implies that the anticipated communication is important relative to other communications in which this user may wish to participate in the near future. In this example:

Priority=0.5*Radiality (of calling node)+0.5*HistoricalFrequency (of link between calling and called node)

A third example includes prioritizing a request to connect a call via a highly utilized base station. Requesting to allocation of capacity-limited resources implies that the anticipated communication is important relative to other communications that may occur in the near future within the Social Networks of users within the area of the base station. In this example:

Priority=0.5*CallerPriorityClass (assigned by the network operator)+0.25*CalleePriorityClass (assigned by the network operator)+0.25*BridgeConditionExists (for the link between the caller and the callee)

A fourth example includes prioritizing a request to power-on a sector at a base station to enable call admission. Requesting to allocation of power resources implies that the anticipated communication is important relative to the network operator's profit goals and legal obligations. In this example:

Priority=0.7*CallerPriorityClass (assigned by the network operator)+0.15*Closeness (of caller)+0.15*Closeness (of callee)

Regarding the Resource Allocation Manager (RAM), the RAM operates within an existing node in a telecommunication network, i.e., outside the scope of the network entity in this example. The network entity's Session Analyzer (SA) provides one or more inputs that affect the conditions triggering simple rules existing in the RAM. For example, a rule for a mobile device could be:

```
If (SessionPriority > 0.95 && BatteryLevel > 0.1)
  WakeupDevice( );
Else If (SessionPriority > 0.8 && BatteryLevel > 0.3)
  WakeupDevice( );
Else If (SessionPriority > 0.5 && BatteryLevel > 0.5)
  WakeupDevice( );
```

and a rule for base station sector power control could be:

```
If (SessionPriority > 0.95 && NumActiveSessionsInCell >
90 && CellUtilization > 0.90)
  PowerUpSector(SectorID);
Else If (SessionPriority > 0.8 && NumActiveSessionsInCell >
100 && CellUtilization > 0.95)
  PowerUpSector(SectorID);
Else If (SessionPriority > 0.5 && NumActiveSessionsInCell >
110 && CellUtilization > 0.95
  PowerUpSector(SectorID);
```

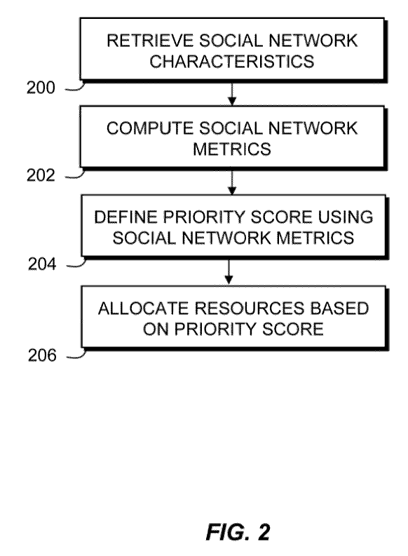

Turning now to FIG. 2, illustrated therein is one method of telecommunication network resource management based on social network characteristics, in accordance with the present invention. At step 200, at least one social network characteristic of a user of the social network is retrieved, preferably upon an event such as session initiation. The particular social network characteristic determined can be any of the characteristics described herein, and can include user interaction and behavior. Preferably, a Social Network Data Crawler obtains these characteristics by monitoring network communications or in response to a query, such as a text message or other transmitted questionnaire. This can include requesting data on the social network characteristics from at least one other network entity that is not logically associated with the user. Member push systems, query systems, stored social network information, or predetermined social network characteristic databases may be used to obtain individual member characteristics as well. The social network characteristics can also include context information, such as presence of specific members in the social network, shared location/time context, group membership, credentials, explicit restriction rules on a particular member, and explicit restriction rules for particular content. Optionally, this step can include aggregating social network characteristics associated with a user's participation in multiple social networks, wherein such aggregation reflecting a relative importance of the user's participation in these multiple social networks.

In a next step 202, the method then computes social network metrics based on the social network characteristic data. This can be done in a Social Network Analysis module of the server. This step can include computing social network metrics include both node-based metrics and network-based metrics, the latter providing a means of comparing network similarity. This step can also include establishing a need to communicate between users, even when there is no a priori linkage between the users.

A next step 204 of the method includes defining a priority score for a communication session with the user based on the social network metrics. This can be accomplished by a Session Analyzer module of the network entity, which is a software agent that recommends priorities for users, based on the metrics, which are preferably weighted. Typically, two or more social metrics are used to define a priority score. Alternatively, the priority score is determined from a set of analytical functions of the metrics based on the resource type. In another alternative, the priority score is determined from a set of analytical functions of the metrics based on a communication type of the session. Optionally, this step can include selecting a policy for managing a resource for a communication session with the user based on the social network metrics. Upon reaching a decision about priority, the Session Analyzer module modifies user priority data 110.

A next step 206 of the method includes allocating resources for the communication session based on the priority score. In a preferred embodiment, the resources of the assigning step include a power operational mode for the session. Optionally, the resources of the allocating step include Admission Control for at least one user for the session.

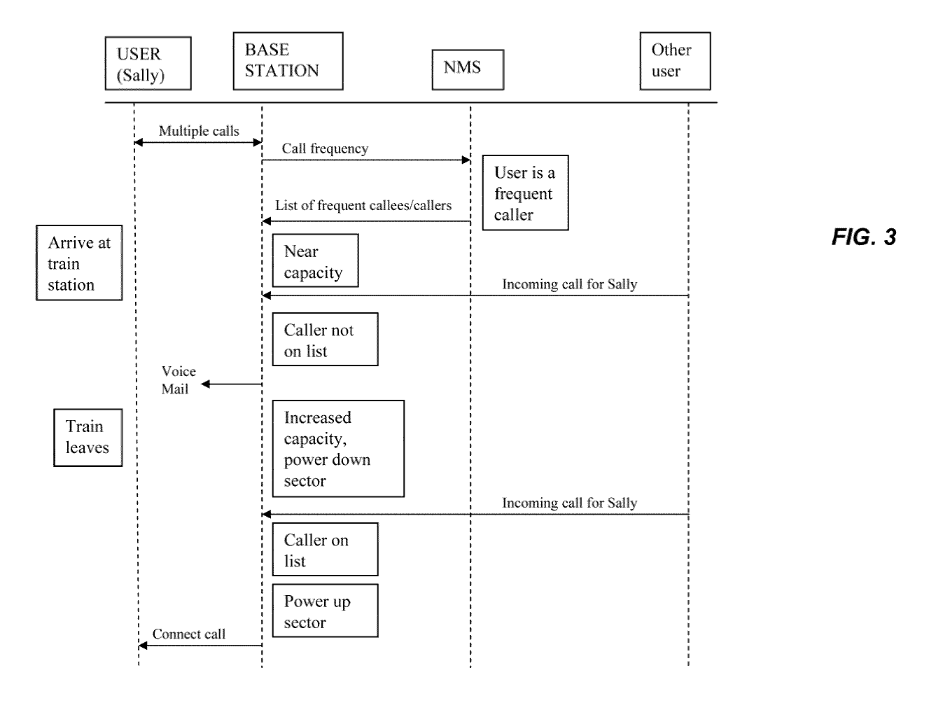

Referring to FIG. 3, a use case is shown, wherein the network entity of FIG. 1 is a base station. In this example, it is assumed that Sally has made multiple (e.g. one hundred) calls via the base station nearest to her train station. Subsequently, her phone is identified as a “frequent caller” by the Network Management System (NMS), which sends to this base station a list of the phone numbers that Sally most frequently calls (or that call her). One day, Sally arrives at her train station, along with a trainload of other passengers making phone calls. Thus, nearly all of the network capacity of the base station is used. There is an incoming call to Sally's phone; the base station intercepts caller ID information for this call, and determines that it is not from a number on her frequent connection list. The base station routes the call to Sally's voice mail, and avoids the need to increase transmission power to maintain an adequate signal-to-noise ratio for an even larger set of subscribers. A few minutes after the train leaves the station, the base station's utilization drops to 65% of capacity; therefore, to save power, one antenna sector is temporarily shut down. Soon after, Sally receives another incoming call; the base station intercepts caller ID information for this call, and determines that it is from a number on her frequent connection list. Because it is from a number on her frequent caller list, the cell site powers-up the antenna sector that was shut down, and connects Sally's call.

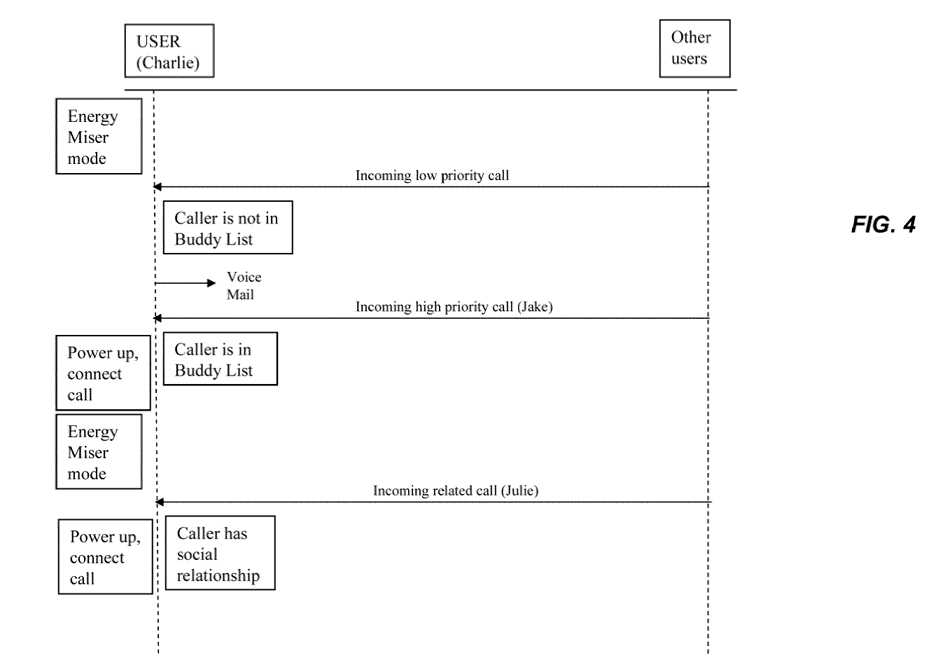

Referring to FIG. 4, a use case is shown, wherein the network entity of FIG. 1 is a mobile station. In this example, Charlie is a member of a community service group. One day, he notices that the battery on his mobile device is running very low. He selects the Energy Miser mode, which only wakes up the device from power-saver mode for Priority 1 sessions. Thus, rather than use the energy that would be needed to ring/vibrate the device, illuminate its display, and maintain an RF connection, the device automatically diverts lower priority calls to Charlie's voice mail. The next call is from Jake, whose device is included in Charlie's Buddy List. Therefore, the device accepts this incoming call, and rings/vibrates the device. The next call is from Julie. Although Charlie doesn't know her, Julie is part of the Social Network for another community group. She is currently participating in a session with the local Police Department responding to an Amber Alert (for a missing child). Using the Social Network Data that had previously been communicated to Charlie's mobile device, e.g., during period of low device and network utilization, the device recognizes that Julie is a member of a Social Network that is highly relevant to Charlie's interests. Subsequently, Charlie's device accepts this incoming call.

In the use cases above, the Social Network Data Crawler, Social Network Analyzer, Session Analyzer, and optionally the Resource Allocation Manager are implemented as agents in the network entity and include software for executing the steps of the method of FIG. 2. The use cases of FIGS. 3 and 4, for instance, may be coded into executable code operable with a processor of the network entity.

Although the two use cases presented above are related to geography, it should be recognized that geography does not constrain the Social Networks interactions monitored, analyzed, and aided by the present invention. For example, a called party may need to acquire a communication channel from a wireless base station in her geographic vicinity; however, the calling party may be far away. The present invention uses information about both parties as it generates user and/or session prioritization scores. In addition, message content plays an important role. First, it provides an indication of who is participating in the session, e.g., via Caller ID. Second, message content may indicate the type of interaction between the parties in a session. In one implementation, Social Network metric calculations are weighted according to the type of session, thereby giving more importance to links in the network communicating in certain ways, e.g., “Voice Call”, or for certain purposes (as might be identified by Text Mining or Voice Recognition), e.g., “Amber Alert”.

Advantageously, the present invention provides power reduction determined by users' priority and characteristics within a Social Network. The present invention could be integrated in existing communication systems that manage call groups/buddy lists. For Push-to-X (PTX) applications, the present invention has the added benefit of reducing the latency of communications.

It will be understood that the terms and expressions used herein have the ordinary meaning as is accorded to such terms and expressions by persons skilled in the field of the invention as set forth above except where specific meanings have otherwise been set forth herein.

The sequences and methods shown and described herein can be carried out in a different order than those described. The particular sequences, functions, and operations depicted in the drawings are merely illustrative of one or more embodiments of the invention, and other implementations will be apparent to those of ordinary skill in the art. The drawings are intended to illustrate various implementations of the invention that can be understood and appropriately carried out by those of ordinary skill in the art. Any arrangement, which is calculated to achieve the same purpose, may be substituted for the specific embodiments shown.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate.

Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of telecommunication network resource management based on social network characteristics, the method comprising the steps of:
retrieving data relating to social network characteristics associated with a user;
computing social network metrics based on the data;
defining a priority score for a communication session with the user based on the social network metrics; and
allocating resources for the communication session based on the priority score.

2. The method of claim 1, wherein the resources of the allocating step include a power operational mode for the session.

3. The method of claim 1, wherein the resources of the allocating step include Admission Control for at least one user for the session.

4. The method of claim 1, wherein the retrieving step includes requesting data on the social network characteristics from at least one other network entity that is not logically associated with the user.

5. The method of claim 1, wherein the defining step defines a priority score that includes at least two social network metrics.

6. The method of claim 5, wherein the at least two social network metrics are weighted.

7. The method of claim 5, wherein the priority score is determined from a set of analytical functions of the metrics based on the resource type.

8. The method of claim 5, wherein the priority score is determined from a set of analytical functions of the metrics based on a communication type of the session.

9. The method of claim 1, further comprising the step of storing social network information, and wherein the retrieving step includes retrieving the stored social network information to include in the data.

10. The method of claim 1 wherein the retrieving step occurs upon communication session initiation.

11. The method of claim 1, wherein the social network characteristics of the retrieving step include user interaction and behavior.

12. The method of claim 1, wherein the retrieving data step includes aggregating social network characteristics associated with a user's participation in multiple social networks, wherein such aggregation reflects a relative importance of the user's participation in these multiple social networks.

13. The method of claim 1, wherein the social network metrics of the computing step includes both node-based metrics and network-based metrics providing a means of comparing network similarity.

14. The method of claim 13, wherein the computing step includes establishing a need to communicate.

15. The method of claim 14, wherein there is no a priori linkage between two users of the session.

16. The method of claim 1, wherein the defining step includes selecting a policy for managing a resource for a communication session with the user based on the social network metrics.

17. A network entity for telecommunication network resource management based on social network characteristics, the network entity comprising:
a resource allocation manager operable to:
query a session analyzer for a priority score for a communication session with the user based on social network metrics computed in a social network analyzer based on data from a social network data crawler relating to social network characteristics associated with a user; and
allocate resources for the communication session based on the priority score.

18. A system of telecommunication network resource management based on social network characteristics, the system comprising:
a social network data crawler operable to retrieve data relating to social network characteristics associated with a user;
a social network analyzer operable to compute social network metrics based on the data;
a session analyzer operable to define a priority score for a communication session with the user based on the social network metrics; and
a resource allocation manager operable to allocate resources for the communication session based on the priority score.
